(19) United States
(12) Patent Application Publication
(10) Pub. No.: US 2024/0011781 A1
(43) Pub. Date: Jan. 11, 2024

(54) METHOD AND SYSTEM FOR ASYNCHRONOUS NEGOTIATION OF AUTONOMOUS VEHICLE STOP LOCATIONS

(71) Applicant: Argo AI, LLC, Pittsburgh, PA (US)

(72) Inventors: Bradley Dryer, Pittsburgh, PA (US); Noe Brito, Cupertino, CA (US); Steven Nielsen, Pittsburgh, PA (US); Shenglong Gao, Miami, FL (US)

(21) Appl. No.: 18/147,184

(22) Filed: Dec. 28, 2022

Related U.S. Application Data
(60) Provisional application No. 63/359,449, filed on Jul. 8, 2022.

(51) Int. Cl. G01C 21/34; G01C 21/36; G06Q 10/02; G06Q 50/30

(52) U.S. Cl. CPC G01C 21/3438; G01C 21/3691; G01C 21/362; G06Q 10/02; G06Q 50/30

(57) ABSTRACT

This document discloses system, method, and computer program product embodiments for determining an intermediate (i.e., alternate) stopping location (ISL) for a ride service request when a desired stopping location (DSL) is not reachable. The system will map and sensor data to select an ISL. In response to determining that the passenger has approved the ISL as a final stopping location (FSL), the vehicle will move along a route to the FSL.

### RELATED APPLICATIONS AND CLAIM OF PRIORITY

This patent document claims priority to U.S. Provisional Patent Application No. 63/359,449, filed Jul. 8, 2022, the disclosure of which is fully incorporated into this document by reference.

### BACKGROUND

When a vehicle is used as a taxi, ride-sharing service, shuttle, delivery vehicle, or other vehicle that will pick up and/or drop off a passenger or package at a location, the vehicle or its operator must navigate to a destination to perform the pickup or drop-off action.

The general concept of “destination” is typically an address, set of coordinates, or other information that specifies where a passenger, package sender, or package recipient would like the vehicle to perform the pickup or drop-off action. However, the generic concept of destination does not necessarily identify the specific location where the vehicle will actually perform the operation. In vehicle service trips such as those described above, the desired stopping location (DSL) of the person (i.e., the passenger, or the package sender or recipient) may not necessarily reflect the actual coordinates of the location where the vehicle will be able to stop. Instead, the vehicle may need to stop at an intermediate stopping location (ISL) that is before or after the DSL. When this happens, the person waiting for the vehicle may not see the vehicle's arrival, or the passenger may not be dropped off at their exact DSL. When this happens, time and operational efficiency can be lost as the parties find and connect with each other, and the person may be inconvenienced by walking some distance before reaching the vehicle or the DSL.

The issue described above is heightened in autonomous vehicles (AVs). When an AV cannot stop precisely at a DSL, the AV may need to negotiate with its dispatching service to select a suitable ISL. However, it is often possible that the AV is owned and/or operated by a fleet operator who is not the same entity as the package delivery service or rideshare service that initiated the trip request. This means that the dispatching service may not have complete information about the AV's characteristics and capabilities, which can make it difficult for the dispatching service to determine which ISLs are suitable for the trip.

This document describes methods and systems that are directed to addressing the problems described above, and/or other issues.

### SUMMARY

At least some of the problems associated with the existing solutions will be shown solved by the subject matter of the independent claims that are included in this document. Additional advantageous aspects are discussed in the dependent claims.

In this document, methods, and systems and computer program products for implementing methods, of determining a stopping location for a ride service request are disclosed. In some embodiments, the methods include, by a processor onboard a vehicle receiving a ride service request, wherein the ride service request includes a desired stopping location (DSL) for a passenger. In response to the DSL not being a reachable stopping location, the methods may include using map data received from the map service and sensor data captured by one or more sensors onboard the vehicle to select an intermediate stopping location (ISL). The vehicle will transmit, to the dispatching service, a message that includes the ISL. The methods may then include, in response to determining that the passenger has approved the ISL, using the ISL to identify a final stopping location (FSL), and causing a motion control system of the vehicle to move the vehicle along a route to the FSL.

In other embodiments, a dispatching service may identify the ride service request, wherein the ride service request includes a DSL for a passenger. The dispatching service will transmit the ride service request to a vehicle. The dispatching service will receive, from the vehicle, an intermediate stopping location (ISL) that is an alternative to the DSL. The dispatching service will send the passenger a message that includes the ISL. In response to determining that the passenger has rejected the ISL, the dispatching service will send the vehicle a message indicating that the passenger has rejected the ISL. The dispatching service will repeat the receiving step and both sending steps above until either the passenger accepts an alternate ISL or the system determines that no suitable ISLs are available.

The methods described above may be embodied in a system including a processor and memory containing programming instructions that, when executed, will cause the processor to implement the actions described above. Various embodiments also include a computer program product that contains such programming instructions, and a memory containing the computer program product.

### BRIEF DESCRIPTION OF THE DRAWINGS

The accompanying drawings are incorporated into this document and form a part of the specification.

FIG. 1 illustrates an example situation in which a dispatching service receives a ride service request and assigns that request to a vehicle.

FIGS. 2A and 2B illustrate the concepts of Desired Stopping Location, Intermediate Stopping Location, and Final Stopping Location as used in this document.

FIG. 3 is a flowchart of a method by which a vehicle and a dispatching service negotiate a final stopping location, in which the method is described from the point of view of the vehicle.

FIG. 4 is a flowchart of a method by which a vehicle and a dispatching service negotiate a final stopping location, in which the method is described from the point of view of the dispatching service.

FIG. 5 illustrates an example architecture for a vehicle, in accordance with aspects of the disclosure.

FIG. 6 is an example computer system useful for implementing various embodiments.

FIG. 7 is a block diagram that illustrates example subsystems of an autonomous vehicle.

In the drawings, like reference numbers generally indicate identical or similar elements. Additionally, generally, the left-most digit(s) of a reference number identifies the drawing in which the reference number first appears.

In the drawings, like reference numbers generally indicate identical or similar elements. Additionally, generally, the left-most digit(s) of a reference number identifies the drawing in which the reference number first appears.

### DETAILED DESCRIPTION

This document describes system, apparatus, device, method and/or computer program product embodiments, and/or combinations and sub-combinations of any of the above, for selecting a stopping location for a vehicle in a system in which the vehicle is an autonomous vehicle (AV), the dispatching service is automatic, or both.

For simplicity, except where specifically denoted, when the term “passenger” is used in this disclosure and in the claims, that term is intended to cover not only a person, but also an object such as a package, or an entity who desires to send or receive a package.

In this document, the term “ride service” is intended to include both passenger and package transportation services. A ride service may include any or all of the following elements: (1) navigating to a pickup location, and in particular a location at which the AV can stop to allow the passenger to get into the vehicle in compliance with permissible stopping criteria; (2) picking up the passenger by stopping for sufficient time for the passenger to board, and (optionally) time to complete one or more other pickup tasks; (3) navigating to a drop-off location, and in particular a location at which the AV can stop to allow the passenger to disembark in compliance with permissible stopping criteria; and (4) dropping off the passenger by stopping for sufficient time for the passenger to exit the vehicle, and (optionally) time to complete one or more other drop-off tasks. Elements (1) and (2) may be skipped if the vehicle is starting at a fixed point of origin such as a loading terminal, parking lot, or other predetermined location that is not dynamically determined.

When navigating in an environment, AVs rely on high definition (HD) maps. An HD map is a set of digital files containing data about physical details of a geographic area such as roads, lanes within roads, traffic signals and signs, barriers, and road surface markings. An AV uses HD map data to augment the information that the AV's on-board cameras, lidar system and/or other sensors perceive. The AV's on-board processing systems can quickly search map data to identify features of the AV's environment and/or to help verify information that the AV's sensors perceive.

This document will discuss the concepts of “Desired Stopping Location” (DSL), “Intermediate Stopping Location” (ISL), and “Final Stopping Location” (FSL). As used in this document, a Desired Stopping Location (DSL) is a location for which a passenger submits a request for a pickup or drop-off operation. In other words, it is the location at which the passenger asks to board or exit the vehicle. An Intermediate Stopping Location (ISL) is an alternate stopping location that is near the DSL and suitable for an AV to perform a pickup or drop-off operation when the DSL cannot be served.

A Final Stopping Location (FSL) is the location at which the vehicle actually stops to perform the pickup or drop-off operation. The FSL may be the DSL, the ISL, or another location.

Definitions for various other terms that are relevant to this document are included at the end of this Detailed Description.

This document describes the present solution in the context of an AV. However, the present solution is not limited to AV applications. The present solution may be used in systems that guide a driver of a non-autonomous vehicle, as well as in other applications such as those of other robotic systems.

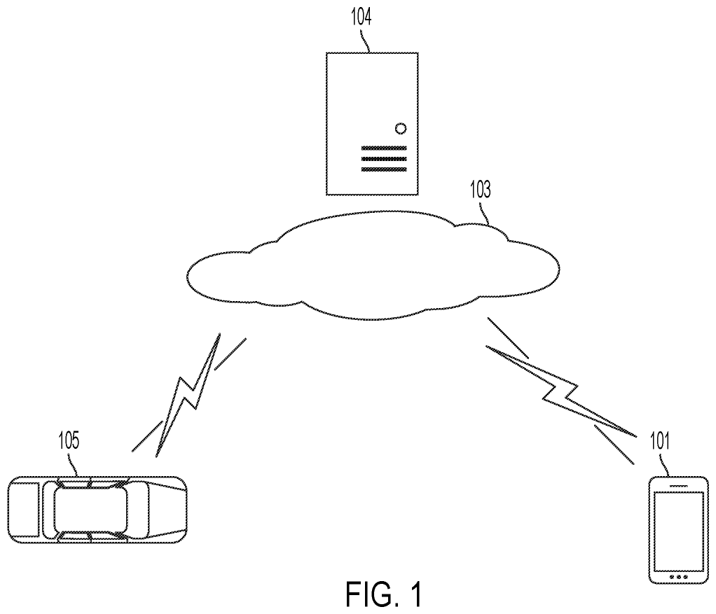

The processes described in this document start with transmission and receipt of a ride service request, which is illustrated by way of example in FIG. 1, in which a transceiver of a vehicle 105 such as an AV receives a ride service request that a passenger electronic device 101 transmitted via a wireless communication network 103. The request is shown as transmitted via a dispatching service 104, which is a remote server that receives ride service requests, selects a vehicle that will implement the request, and relays instructions for the ride service request to the assigned vehicle, in each case via one or more communication networks 103. In some embodiments, the ride service request could also be transmitted directly from the passenger electronic device 101 to the vehicle 105, such as by a Bluetooth or other near-field or short-range communication, in which the request could be to initiate a new ride service request or alter an existing ride service request. In addition, a ride service request may be directly input into a user interface of the vehicle 105, such as an in-dash touch screen display or a microphone that is part of a vehicle speech-to-text conversion system. In such cases, the vehicle may still need to negotiate with a dispatcher to ensure that the vehicle has permission to act on the request, and/or to receive route and destination information.

The passenger electronic device 101 is an electronic device containing a browser, a dedicated ride service application or another application via which a user of the device may submit a request for a vehicle ride by entering a starting point, a destination, or both. The request will be in the form of data, transmitted via data packets, that includes a DSL which may be a location for a loading operation or an unloading operation, and optionally other information such as identifying information about the passenger, as well as a pick-up time. The operator of the electronic device 101 may be the passenger who is requesting the ride, or someone else who is requesting the ride on behalf of the passenger.

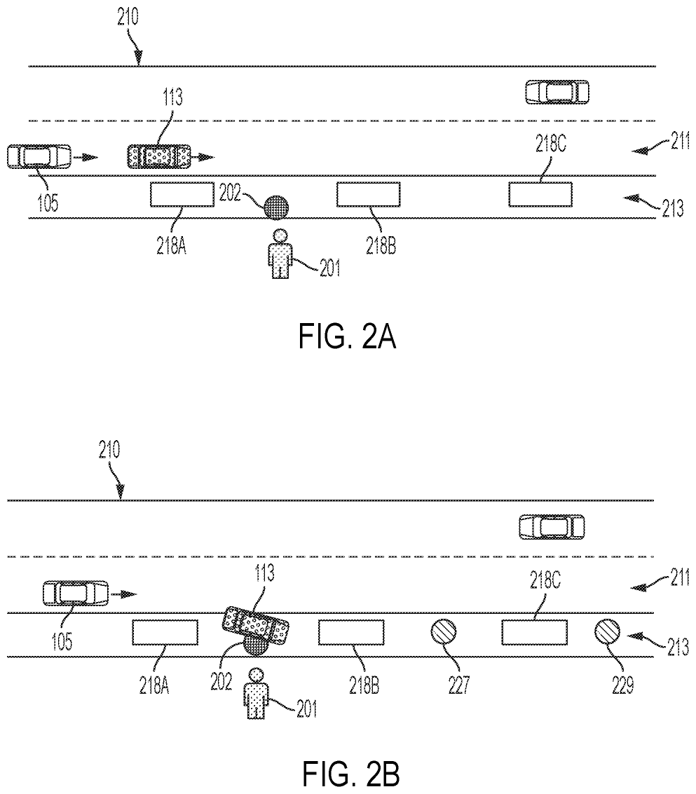

The concepts of DSL, ISL and FSL are illustrated by way of example in FIGS. 2A and 2B. In FIG. 2A, an AV 105 has access to an HD map of an area, which in this example is a grid of several blocks of city streets, including street 210. Street 210 includes multiple lanes, including the AV's lane of travel 211 and a curbside or parking lane 213. The map will typically be stored in a memory device onboard the vehicle, although it could also be stored on a mobile electronic device or offboard server that is in communication with the AV. The map may be periodically updated by the remote server and/or augmented by information that the AV's perception system detects as the AV 105 moves through the area.

The AV 105 receives a service request to pick up or drop off a passenger 201 or package at a DSL 202. The AV 105 then determines a path or route via which the AV 105 may navigate to the DSL 202. The path will be a sequence of lane segments leading up to and including the DSL 202. As shown in FIG. 2A, any number of obstacles 218A-218C may be positioned near the DSL 202. The obstacles 218A-218C, which this document also may refer to alternatively as obstructions or occlusions, may be other vehicles, people, structures, signs or other items that prevent the AV 105 from reaching the DSL 202.

In FIG. 2A, no obstacles prevent the AV 105 from accessing the DSL 202. However, as time passes and the AV gets closer to the DSL, FIG. 2B illustrates that another vehicle 113 that was in front of the AV 105 enters the DSL and thus blocks access to the DSL 202. This prevents the AV 105 from stopping at the DSL 202. The AV's perception system will identify and detect this, and since the DSL is blocked the AV's motion planning system must determine one or more intermediate stopping locations such as first ISL 227 or second ISL 229 into which the AV 105 may move.

To qualify as an ISL, the location may be required to satisfy certain rules and/or exhibit certain characteristics such as: (a) the ISL must be within a threshold distance from the DSL; (b) the passenger must not be required to cross a street to reach the IDS; (c) the ISL must have at least minimum size dimensions; (d) the boundaries of the ISL must be at least a minimum distance from a nearest intersection; (e) the ISL must be in a lane of an approved type, or not be in a lane of a restricted type; and/or (f) other criteria. Optionally, the system may assign weights or scores to each of the parameters and require the ISL to have at least a threshold total score. Other functions based on other criteria may be used.

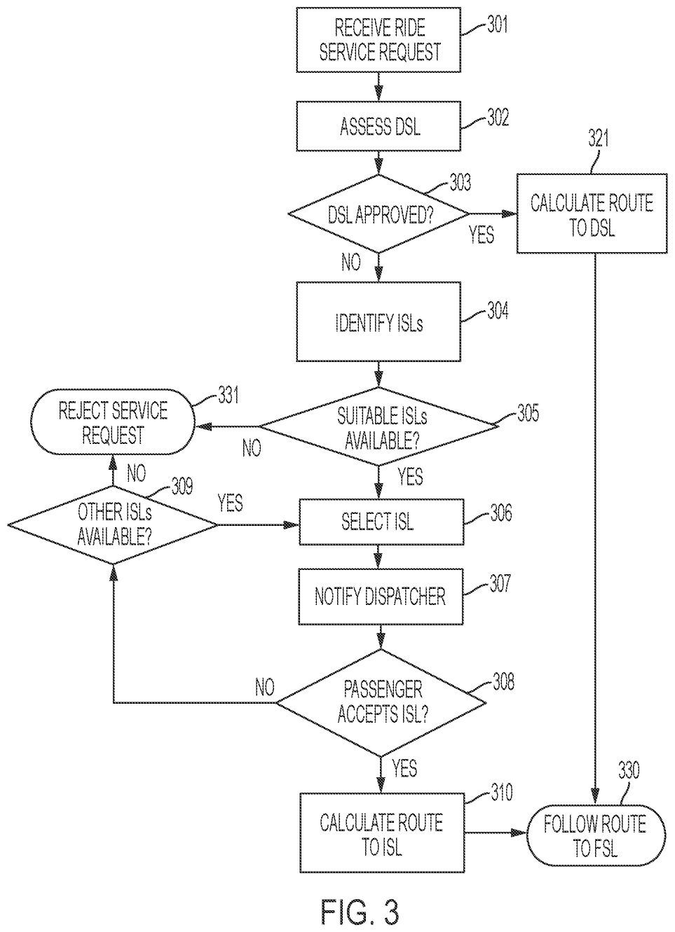

FIG. 3 is a flowchart illustrating a process by which a vehicle negotiates with a dispatching service to a identify a FSL for a ride service. FIG. 3 describes the process from the point of view of the vehicle. At 301 by a processor onboard the vehicle will receive a ride service request. The ride service request will include a desired stopping location (DSL). The vehicle may receive the ride service request from a dispatching service, or from a passenger or other entity who initiated the ride service request. At 302 the vehicle, the dispatching service, or both will assess the DSL to determine whether the DSL is a reachable stopping location. To do this, the system may use any suitable information and rules, such as:
accessing HD map data and using the map data determine whether the DSL corresponds to a permissible stopping location; if the DSL is in a crosswalk, in an intersection, or in another area in which stopping restricted the system may not approve the DSL to be used as the FSL; or
using data captured by the vehicle's perception system (such as cameras and/or lidar system) to identify whether an obstruction will prevent the vehicle from reaching the DSL.

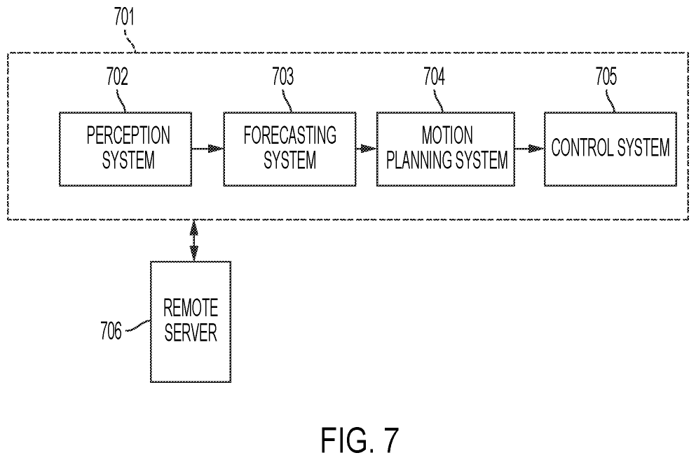

In various embodiments, the system and the vehicle must both approve the DSL, or at least one of those elements must approve the DSL and the other must not disapprove it, or both of those elements must not object to the DSL (in which the failure to object will be considered approval). If the system approves the DSL (303: YES), then at 321 the system will calculate a route to the DSL, and at 330 the vehicle will follow the route to the DSL. Methods by which the system may do this are described below in the context of FIG. 7.

If the system does not approve the DSL (303: NO), then at 304 the vehicle and/or dispatching service will determine whether one or more suitable ISLs are available. Methods and rules for doing this will be described below. If no suitable ISLs are available (305: NO), then at 331 the system will reject the ride service request, the dispatcher or vehicle will send notification of the rejection to the passenger, and the vehicle will not fulfill the ride service request unless and until the passenger selects a new DSL.

To select a suitable ISL, the location must satisfy at least the same criteria as those described above for a DSL at step 302. In addition, the ISL must be a location that is within a maximum threshold walking distance from the DSL. The system may use Euclidean distance (i.e., a straight line), or it may use a different distance metric such as the Manhattan distance as determined from the HD map data. The threshold distance may be a fixed threshold or, in some embodiments, if the system has access to a weather service, the system may receive weather data indicative of a weather condition at the DSL, and the system may select the maximum threshold walking distance that corresponds to the weather condition. The system may do this using a lookup table or a rule that, for example, reduces the threshold by a percentage or numeric amount when the weather conditions include rain or snow. In some embodiments, the vehicle may access a stopping location rule set that is associated with the dispatching service, and it may retrieve the maximum threshold walking distance from the stopping location rule set.

Optionally, the system may use other rules or criteria to determine which ISLs qualify as suitable ISLs. For example, in some embodiments the system may require that, to qualify as a suitable ISL, the location must satisfy at least one of the following rules: (i) the passenger must not need to cross a street when walking from the ISL to the DSL; (ii) the ISL must be located more than a minimum distance from a nearest intersection; or (iii) the ISL must be of at least a minimum size. Other rules may apply in various embodiments.

If one or more suitable ISLs are available (305: YES), then at 306 the vehicle may select one of the suitable ISLs to serve as a tentative DSL. If only one suitable ISL is available, then that DSL may be considered to be automatically selected. If multiple ISLs are available, then the vehicle may choose the ISL from the suitable ISLs using rules such as (a) choose the ISL that is the shortest walking distance from the ISL; (b) choose the ISL that the vehicle will reach first; or (c) other rules. At 307 the vehicle will transmit, to the dispatching service, a message that includes the selected ISL. However, the vehicle does not need to send the dispatching service all, or any, of the information or criteria that the vehicle used to select the ISL.

The dispatching service will then send a message to the passenger to confirm that the passenger accepts the ISL. The passenger may actively accept the ISL, or the passenger may passively accept the ISL by not objecting to the ISL within a threshold period of time.

If the passenger objects to the ISL (308: NO), then the dispatching service may notify the vehicle of this fact. If other ISLs are available (309: YES), then the vehicle may select an alternate ISL (returning to step 306), and the process will repeat with the alternate ISL.

The vehicle may determine that the passenger accepts the ISL (308: YES) by either (a) receiving a message from the dispatching service that notifies the vehicle of this fact, or (b) not receiving notice of rejection within a threshold period of time.

When the passenger accepts the ISL (308: YES), then in response the vehicle will use the ISL to identify a final stopping location (FSL), calculate a route to that location at 310, and causing a motion control system of the vehicle to move the vehicle along a route to the FSL at 330. As noted above, methods by which the vehicle may calculate a route and move along the route are described below in the context of FIG. 7.

Notably, in the process above, the selection of the ISL is a negotiation between the vehicle and the dispatcher; the vehicle and the passenger need not communicate with each other before the processor identifies the FSL and causes the vehicle to move along the route.

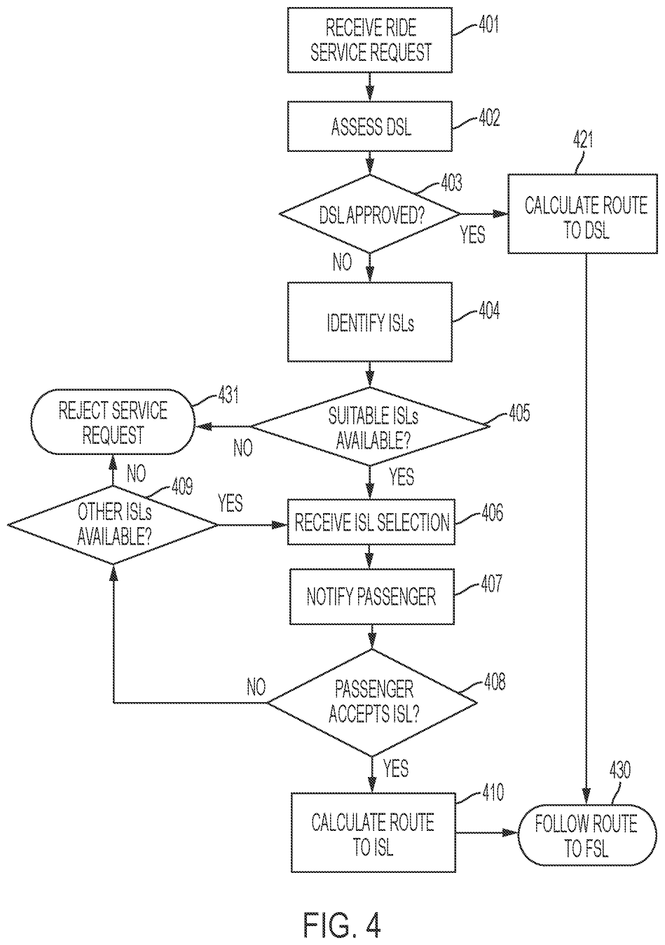

FIG. 4 is a flowchart illustrating the process of FIG. 3 from the point of view of the dispatching service. At 401 a processor of the dispatching service will receive a ride service request. The ride service request will include a desired stopping location (DSL). The dispatching service may receive the ride service request from a passenger or other entity who initiated the ride service request, or from a vehicle. At 402 the dispatching service, the vehicle, or both will assess the DSL to determine whether the DSL is a reachable stopping location. To do this, the system may use any suitable information and rules, such as those described above in the context of step 302 of FIG. 3.

In various embodiments, the system and the vehicle must both approve the DSL, or at least one of those elements must approve the DSL and the other must not disapprove it, or both of those elements must not object to the DSL (in which the failure to object will be considered approval). If the system approves the DSL (403: YES), then at 421 the vehicle or the dispatching service will calculate a route to the DSL, and at 430 the vehicle will follow the route to the DSL. Methods by which the system may do this are described below in the context of FIG. 7.

If the system does not approve the DSL (403: NO), then at 404 the vehicle and/or dispatching service will determine whether one or more suitable ISLs are available. Methods and rules for doing this will be described below. If no suitable ISLs are available (405: NO), then at 431 the system will reject the ride service request, the dispatcher or vehicle will send notification of the rejection to the passenger, and the vehicle will not fulfill the ride service request unless and until the passenger selects a new DSL.

To identify suitable ISLs, the locations must satisfy at least the same criteria as those described above for a DSL at step 403. In addition, to be a suitable ISL, it must be a location that is within a maximum threshold walking distance from the DSL. Example criteria and rules of for identifying suitable ISLs at 404 include those discussed above for step 304 of FIG. 3. If the vehicle identifies the suitable ISLs, the dispatching service may send the stopping rules to the vehicle. Alternatively, the vehicle may send multiple ISLs to the dispatching service, and the dispatching service may eliminate from the set of suitable ISLs any ISLs that do not satisfy the stopping rules.

If one or more suitable ISLs are available (405: YES), then at 406 the dispatching service may receive a message from the vehicle indicating that the vehicle has selected one of the suitable ISLs to serve as a tentative DSL. If only one suitable ISL is available, then that DSL may be considered to be automatically selected. At 407 the dispatching service will transmit, to the passenger, a message that includes the selected ISL. Notably, the dispatching service does not need to receive all, or any, of the information or criteria that the vehicle used to select the ISL.

The passenger may actively accept the ISL, or the passenger may passively accept the ISL by not objecting to the ISL within a threshold period of time. If the passenger objects to the ISL (408: NO), then the dispatching service may notify the vehicle of this fact. If other ISLs are available (409: YES), then the vehicle may select an alternate ISL (returning to step 406), and the process will repeat with the alternate ISL.

When the passenger accepts the ISL (408: YES), then in response the vehicle will use the ISL to identify a final stopping location (FSL), calculate a route to that location at 410, and cause a motion control system of the vehicle to move the vehicle along a route to the FSL at 430. As noted above, methods by which the vehicle may calculate a route and move along the route are described below in the context of FIG. 7.

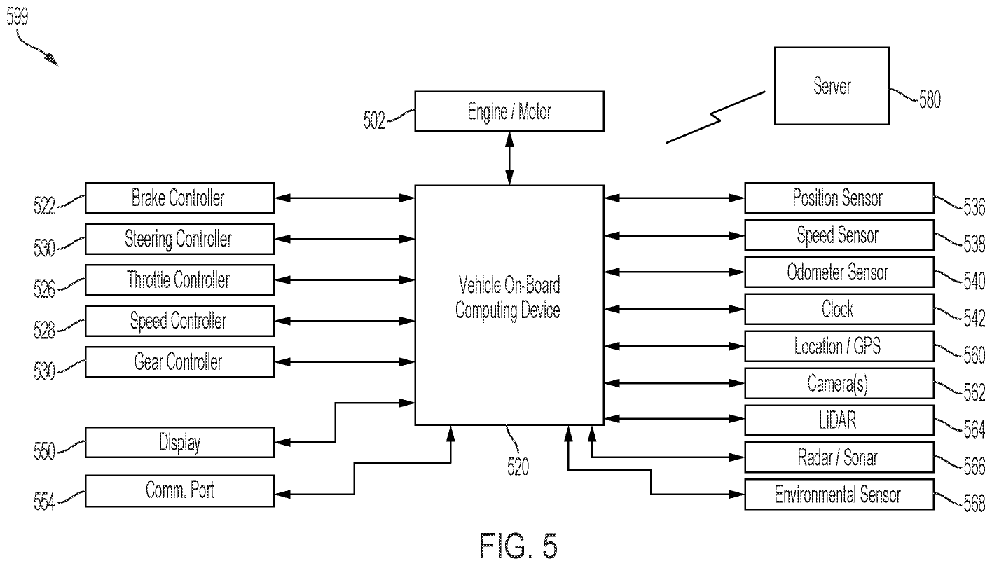

FIG. 5 illustrates an example system architecture 599 for a vehicle, in accordance with aspects of the disclosure. Vehicle 105 of FIGS. 1 and 2A-2B can have the same or similar system architecture as that shown in FIG. 5. However, other types of vehicles are considered within the scope of the technology described in this document and may contain more or fewer elements than those described in association with FIG. 5. As a non-limiting example, an airborne vehicle may exclude brake or gear controllers, but may include an altitude sensor. In another non-limiting example, a water-based vehicle may include a depth sensor. One skilled in the art will appreciate that other propulsion systems, sensors and controllers may be included based on a type of vehicle, as is known.

As shown in FIG. 5, system architecture 599 for a vehicle includes an engine or motor 502 and various sensors for measuring various parameters of the vehicle and/or its environment. Such sensors may include, for example: a position sensor 536 such as an accelerometer, gyroscope and/or inertial measurement unit; a speed sensor 538; and an odometer sensor 540. The vehicle also may have a clock 542 that the system uses to determine vehicle time during operation. The clock 542 may be encoded into the vehicle on-board computing device, it may be a separate device, or multiple clocks may be available.

The vehicle also may include various sensors that operate to gather information about the environment in which the vehicle is traveling. These sensors may include, for example: a location sensor 560 (such as a Global Positioning System (“GPS”) device); object detection sensors such as one or more cameras 562; a lidar system 564; and/or a radar and/or a sonar system 566. The sensors also may include environmental sensors 568 such as a precipitation sensor and/or ambient temperature sensor. The object detection sensors may enable the vehicle to detect objects that are within a given distance range of the vehicle in any direction, while the environmental sensors collect data about environmental conditions within the vehicle's area of travel.

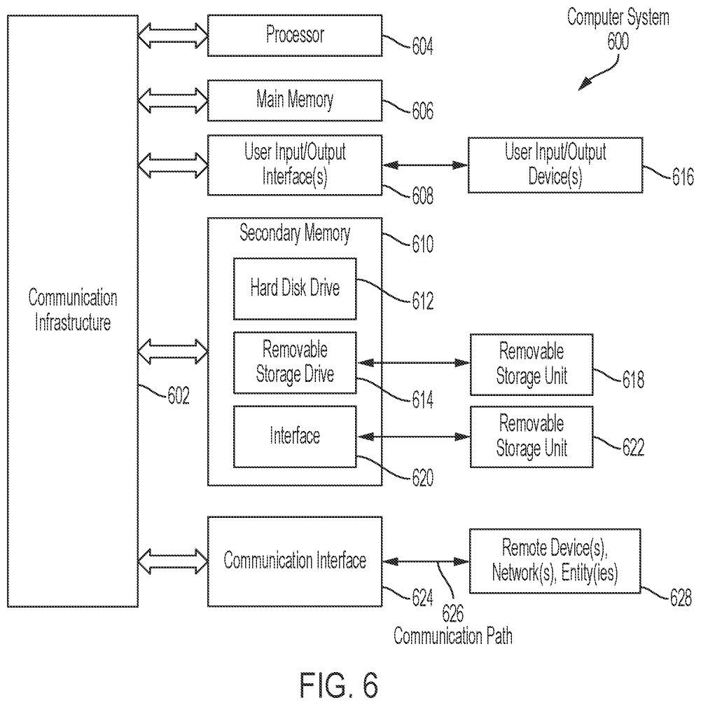

During operations, information is communicated from the sensors to a vehicle on-board computing device 520. The on-board computing device 520 may be implemented using the computer system of FIG. 6. The vehicle on-board computing device 520 analyzes the data captured by the sensors and optionally controls operations of the vehicle based on results of the analysis. For example, the vehicle on-board computing device 520 may control: braking via a brake controller 522; direction via a steering controller 530; speed and acceleration via a throttle controller 526 (in a gas-powered vehicle) or a motor speed controller 528 (such as a current level controller in an electric vehicle); a differential gear controller 530 (in vehicles with transmissions); and/or other controllers. Other device controllers may be configured to control one or more auxiliary devices, such as testing systems, auxiliary sensors, mobile devices transported by the vehicle, etc.

Geographic location information may be communicated from the location sensor 560 to the on-board computing device 520, which may then access a map of the environment that corresponds to the location information to determine known fixed features of the environment such as streets, buildings, stop signs and/or stop/go signals. Captured images from the cameras 562 and/or object detection information captured from sensors such as lidar system 564 is communicated from those sensors) to the on-board computing device 520. The object detection information and/or captured images are processed by the on-board computing device 520 to detect objects in proximity to the vehicle. Any known or to be known technique for making an object detection based on sensor data and/or captured images can be used in the embodiments disclosed in this document.

Lidar information is communicated from lidar system 564 to the on-board computing device 520. Additionally, captured images are communicated from the camera(s) 562 to the vehicle on-board computing device 520. The lidar information and/or captured images are processed by the vehicle on-board computing device 520 to detect objects in proximity to the vehicle. The manner in which the object detections are made by the vehicle on-board computing device 520 includes such capabilities detailed in this disclosure.

In addition, the system architecture 599 may include an onboard display device 550 that may generate and output an interface on which sensor data, vehicle status information, or outputs generated by the processes described in this document are displayed to an occupant of the vehicle. The display device may include, or a separate device may be, an audio speaker that presents such information in audio format. The system architecture 599 also may include a communication port 554 that includes or is connected to a transceiver or other communication equipment for sending messages to, and receiving messages from, other devices such as a remote server 580 that is a dispatching service.

The on-board computing device 520 may include and/or may be in communication with a routing controller that generates a navigation route from a start position to a destination position for an autonomous vehicle. The routing controller may access a map data store to identify possible routes and road segments that a vehicle can travel on to get from the start position to the destination position. The routing controller may score the possible routes and identify a preferred route to reach the destination. For example, the routing controller may generate a navigation route that minimizes Euclidean distance traveled or another cost function during the route, and may further access the traffic information and/or estimates that can affect an amount of time it will take to travel on a particular route. Depending on implementation, the routing controller may generate one or more routes using various routing methods, such as Dijkstra's algorithm, Bellman-Ford algorithm, or other algorithms. The routing controller may also use the traffic information to generate a navigation route that reflects expected conditions of the route (e.g., current day of the week or current time of day, etc.), such that a route generated for travel during rush-hour may differ from a route generated for travel late at night. The routing controller 532 may also generate more than one navigation route to a destination and send more than one of these navigation routes to a user for selection by the user from among various possible routes.

In various embodiments, the on-board computing device 520 may determine perception information of the surrounding environment of the vehicle. Based on the sensor data provided by one or more sensors and location information that is obtained, the on-board computing device 520 may determine perception information of the surrounding environment of the vehicle. The perception information may represent what an ordinary driver would perceive in the surrounding environment of a vehicle. The perception data may include information relating to one or more objects in the environment of the vehicle. For example, the on-board computing device 520 may process sensor data (e.g., lidar or radar data, camera images, etc.) in order to identify objects and/or features in the environment of the vehicle. The objects may include traffic signals, roadway boundaries, other vehicles, pedestrians, and/or obstacles, etc. The on-board computing device 520 may use any now or hereafter known object recognition algorithms, video tracking algorithms, and computer vision algorithms (e.g., track objects frame-to-frame iteratively over a number of time periods) to determine the perception.

In some embodiments, the on-board computing device 520 may also determine, for one or more identified objects in the environment, the current state of the object. The state information may include, without limitation, for each object: current location; current speed and/or acceleration, current heading; current pose; current shape, size, or footprint; type (for example: vehicle, pedestrian, bicycle, static object or obstacle); and/or other state information.

The on-board computing device 520 may perform one or more prediction and/or forecasting operations. For example, the on-board computing device 520 may predict future locations, trajectories, and/or actions of one or more objects. For example, the on-board computing device 520 may predict the future locations, trajectories, and/or actions of the objects based at least in part on perception information (e.g., the state data for each object comprising an estimated shape and pose determined as discussed below), location information, sensor data, and/or any other data that describes the past and/or current state of the objects, the vehicle, the surrounding environment, and/or their relationship(s). For example, if an object is a vehicle and the current driving environment includes an intersection, the on-board computing device 520 may predict whether the object will likely move straight forward or make a turn. If the perception data indicates that the intersection has no traffic light, the on-board computing device 520 may also predict whether the vehicle may have to fully stop prior to entering the intersection.

In various embodiments, the on-board computing device 520 may determine a motion plan for the autonomous vehicle. For example, the on-board computing device 520 may determine a motion plan for the autonomous vehicle based on the perception data and/or the prediction data. Specifically, given predictions about the future locations of proximate objects and other perception data, the on-board computing device 520 can determine a motion plan for the AV 105 that best navigates the autonomous vehicle relative to the objects at their future locations.

In some embodiments, the on-board computing device 520 may receive predictions and make a decision regarding how to handle objects and/or actors in the environment of the vehicle. For example, for a particular actor (e.g., a vehicle with a given speed, direction, turning angle, etc.), the on-board computing device 520 decides whether to overtake, yield, stop, and/or pass based on, for example, traffic conditions, map data, state of the autonomous vehicle, etc. Furthermore, the on-board computing device 520 also plans a path for the vehicle to travel on a given route, as well as driving parameters (e.g., distance, speed, and/or turning angle). That is, for a given object, the on-board computing device 520 decides what to do with the object and determines how to do it. For example, for a given object, the on-board computing device 520 may decide to pass the object and may determine whether to pass on the left side or right side of the object (including motion parameters such as speed). The on-board computing device 520 may also assess the risk of a collision between a detected object and the vehicle. If the risk exceeds an acceptable threshold, it may determine whether the collision can be avoided if the autonomous vehicle follows a defined vehicle trajectory and/or implements one or more dynamically generated emergency maneuvers is performed in a time period (e.g., N milliseconds). If the collision can be avoided, then the on-board computing device 520 may execute one or more control instructions to perform a cautious maneuver (e.g., mildly slow down, accelerate, change lane, or swerve). In contrast, if the collision cannot be avoided, then the on-board computing device 520 may execute one or more control instructions for execution of an emergency maneuver (e.g., brake and/or change direction of travel).

As discussed above, planning and control data regarding the movement of the autonomous vehicle is generated for execution. The on-board computing device 520 may, for example, control braking via a brake controller; direction via a steering controller; speed and acceleration via a throttle controller (in a gas-powered vehicle) or a motor speed controller (such as a current level controller in an electric vehicle); a differential gear controller (in vehicles with transmissions); and/or other controllers.

Various embodiments can be implemented, for example, using one or more computer systems, such as computer system 600 shown in FIG. 6. Computer system 600 can be any computer capable of performing the functions described in this document.

Computer system 600 includes one or more processors (also called central processing units, or CPUs), such as a processor 604. Processor 604 is connected to a communication infrastructure or bus 602. Optionally, one or more of the processors 604 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 also includes user input/output device(s) 616, such as monitors, keyboards, pointing devices, etc., that communicate with communication infrastructure 602 through user input/output interface(s) 608.

Computer system 600 also includes a main or primary memory 606, such as random access memory (RAM). Main memory 606 may include one or more levels of cache. Main memory 606 has stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be an external hard drive, a universal serial bus (USB) drive, a memory card such as a compact flash card or secure digital memory, a floppy disk drive, a magnetic tape drive, a compact disc drive, an optical storage device, a tape backup device, and/or any other storage device/drive.

Removable storage drive 614 may interact with a removable storage unit 618. Removable storage unit 618 includes a computer usable or readable storage device having stored thereon computer software (control logic) and/or data. Removable storage unit 618 may be an external hard drive, a universal serial bus (USB) drive, a memory card such as a compact flash card or secure digital memory, a floppy disk, a magnetic tape, a compact disc, a DVD, an optical storage disk, and/any other computer data storage device. Removable storage drive 614 reads from and/or writes to removable storage unit 618 in a well-known manner.

According to an example embodiment, secondary memory 610 may include other means, instrumentalities or other approaches for allowing computer programs and/or other instructions and/or data to be accessed by computer system 600. Such means, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 enables computer system 600 to communicate and interact with any combination of remote devices, remote networks, remote entities, etc. (individually and collectively referenced by reference number 628). For example, communication interface 624 may allow computer system 600 to communicate with remote devices 628 over communications path 626, which may be wired and/or wireless, and which may include any combination of LANs, WANs, the Internet, etc. Control logic and/or data may be transmitted to and from computer system 600 via communication path 626.

In some embodiments, a tangible, non-transitory apparatus or article of manufacture comprising a tangible, non-transitory computer useable or readable medium having control logic (software) stored thereon is also referred to in this document as a computer program product or program storage device. This includes, but is not limited to, computer system 600, main memory 606, secondary memory 610, and removable storage units 618 and 622, as well as tangible articles of manufacture embodying any combination of the foregoing. Such control logic, when executed by one or more data processing devices (such as computer system 600), causes such data processing devices to operate as described in this document.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described in this document.

FIG. 7 shows a high-level overview of vehicle subsystems that may be relevant to the discussion above. Specific components within such systems were described in the discussion of FIG. 5 in this document. Certain components of the subsystems may be embodied in processor hardware and computer-readable programming instructions that are part of the vehicle on-board computing system 701.

The subsystems may include a perception system 702 that includes sensors that capture information about moving actors and other objects that exist in the vehicle's immediate surroundings Example sensors include cameras, lidar sensors and radar sensors. The data captured by such sensors (such as digital image, lidar point cloud data, or radar data) is known as perception data. The perception data may include data representative of one or more objects in the environment. The perception system may include one or more processors, along with a computer-readable memory with programming instructions and/or trained artificial intelligence models that, during a run of the vehicle, will process the perception data to identify objects and assign categorical labels and unique identifiers to each object detected in a scene. Categorical labels may include categories such as vehicle, bicyclist, pedestrian, building, and the like. Methods of identifying objects and assigning categorical labels to objects are well known in the art, and any suitable classification process may be used, such as those that make bounding box predictions for detected objects in a scene and use convolutional neural networks or other computer vision models. Some such processes are described in “Yurtsever et al., A Survey of Autonomous Driving: Common Practices and Emerging Technologies” (arXiv Apr. 2, 2020).

If the vehicle is an AV, the vehicle's perception system 702 may deliver perception data to the vehicle's forecasting system 703. The forecasting system (which also may be referred to as a prediction system) will include processors and computer-readable programming instructions that are configured to process data received from the perception system and forecast actions of other actors that the perception system detects.

In an AV, the vehicle's perception system, as well as the vehicle's forecasting system, will deliver data and information to the vehicle's motion planning system 704 and motion control system 705 so that the receiving systems may assess such data and initiate any number of reactive motions to such data. The motion planning system 704 and control system 705 include and/or share one or more processors and computer-readable programming instructions that are configured to process data received from the other systems, determine a trajectory for the vehicle, and output commands to vehicle hardware to move the vehicle according to the determined trajectory. Example actions that such commands may cause the vehicle hardware to take include causing the vehicle's brake control system to actuate, causing the vehicle's acceleration control subsystem to increase speed of the vehicle, or causing the vehicle's steering control subsystem to turn the vehicle. Various motion planning techniques are well known, for example as described in Gonzalez et al., “A Review of Motion Planning Techniques for Automated Vehicles,” published in IEEE Transactions on Intelligent Transportation Systems, vol. 17, no. 4 (April 2016).

In non-AV embodiments, such as with vehicles that are driven by human operators, the motion planning system 704 may be embodied in processor hardware and computer-readable hardware that are part of an electronic devices that is contained with the vehicle, such as a dashboard navigation system or a mobile electronic device of the operator. In such situations, the electronic device may output the trajectories planned by the motion planning system via a display, an audio speaker, or both. In addition, some parts of the perception system 702 may include a transceiver of an electronic device that receives certain perception data (such as weather data) from a remote server via wireless communication.

The vehicle's on-board computing system 701 will be in communication with a remote server 706. The remote server 706 is an external electronic device that is in communication with the vehicle's on-board computing system 701, either via a wireless connection while the vehicle is making a run, or via a wired or wireless connection while the vehicle is parked at a docking facility or service facility. The remote server 706 may receive data that the vehicle collected during its run, such as perception data and operational data. The remote server 706 also may transfer data or other information to the vehicle such as software updates, high definition (HD) map updates, machine learning model updates and other information.

Terms that are relevant to this disclosure include:

As used in this document, the singular forms “a,” “an,” and “the” include plural references unless the context clearly dictates otherwise. Unless defined otherwise, all technical and scientific terms used in this document have the same meanings as commonly understood by one of ordinary skill in the art. As used in this document, the term “comprising” means “including, but not limited to.”

In this document, the term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones and the like. An “autonomous vehicle” (or “AV”) is a vehicle having a processor, programming instructions and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle's autonomous system and may take control of the vehicle.

An “electronic device” or a “computing device” refers to a device that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions.

The terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices. A computer program product is a memory device with programming instructions stored on it.

The terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices, which may be components of a single device or components of separate devices, together or collectively perform a process.

The term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones and the like. An “autonomous vehicle” (or “AV”) is a vehicle having a processor, programming instructions and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle's autonomous system and may take control of the vehicle.

The terms “run” and “trip”, when used in reference to a vehicle, refer to an act of operating a vehicle and causing the vehicle to move about the real world. A run or trip may occur in public, uncontrolled environments such as city or suburban streets, highways, or open roads. A run or trip may also occur in a controlled environment such as a test track.

In this document, the terms “communication link” and “communication path” mean a wired or wireless path via which a first device sends communication signals to and/or receives communication signals from one or more other devices. Devices are “communicatively connected” if the devices are able to send and/or receive data via a communication link. “Electronic communication” refers to the transmission of data via one or more signals between two or more electronic devices, whether through a wired or wireless network, and whether directly or indirectly via one or more intermediary devices. The term “wireless communication” refers to communication between two devices in which at least a portion of the communication path includes a signal that is transmitted wirelessly, but it does not necessarily require that the entire communication path be wireless.

The term “communication network” refers to a communication system that includes one or more wired or wireless networks. For example, the network 103 of FIG. 1 may include a cellular network (for example, a long-term evolution (LTE) network, a code division multiple access (CDMA) network, a 3G network, a 4G network, a 5G network, another type of next generation network, etc.). The network may also include a public land mobile network (PLMN), a local area network (LAN), a wide area network (WAN), a metropolitan area network (MAN), a telephone network (for example, the Public Switched Telephone Network (PSTN)), a private network, an ad hoc network, an intranet, the Internet, a fiber optic-based network, a cloud computing network, and/or the like, and/or a combination of these or other types of networks.

When used in the context of autonomous vehicle motion planning, the term “trajectory” refers to the plan that the vehicle's motion planning system will generate, and which the vehicle's motion control system will follow when controlling the vehicle's motion. A trajectory includes the vehicle's planned position and orientation at multiple points in time over a time horizon, as well as the vehicle's planned steering wheel angle and angle rate over the same time horizon. An autonomous vehicle's motion control system will consume the trajectory and send commands to the vehicle's steering controller, brake controller, throttle controller and/or other motion control subsystem to move the vehicle along a planned path.

A “trajectory” of an actor that a vehicle's perception or prediction systems may generate refers to the predicted path that the actor will follow over a time horizon, along with the predicted speed of the actor and/or position of the actor along the path at various points along the time horizon.

In this document, the terms “street,” “lane,” “road” and “intersection” are illustrated by way of example with vehicles traveling on one or more roads. However, the embodiments are intended to include lanes and intersections in other locations, such as parking areas. In addition, for autonomous vehicles that are designed to be used indoors (such as automated picking devices in warehouses), a street may be a corridor of the warehouse and a lane may be a portion of the corridor. If the autonomous vehicle is a drone or other aircraft, the term “street” or “road” may represent an airway and a lane may be a portion of the airway. If the autonomous vehicle is a watercraft, then the term “street” or “road” may represent a waterway and a lane may be a portion of the waterway.

In this document, when terms such as “first” and “second” are used to modify a noun, such use is simply intended to distinguish one item from another, and is not intended to require a sequential order unless specifically stated. In addition, terms of relative position such as “vertical” and “horizontal”, or “front” and “rear”, when used, are intended to be relative to each other and need not be absolute, and only refer to one possible position of the device associated with those terms depending on the device's orientation.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes example embodiments for example fields and applications, it should be understood that the disclosure is not limited to the disclosed examples. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described in this document. Further, embodiments (whether or not explicitly described) have significant utility to fields and applications beyond the examples described in this document.

Embodiments have been described in this document with the aid of functional building blocks illustrating the implementation of specified functions and relationships. The boundaries of these functional building blocks have been arbitrarily defined in this document for the convenience of the description. Alternate boundaries can be defined as long as the specified functions and relationships (or their equivalents) are appropriately performed. Also, alternative embodiments can perform functional blocks, steps, operations, methods, etc. using orderings different than those described in in this document.

The features from different embodiments disclosed herein may be freely combined. For example, one or more features from a method embodiment may be combined with any of the system or product embodiments. Similarly, features from a system or product embodiment may be combined with any of the method embodiments herein disclosed.

References in this document to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described in this document

The breadth and scope of this disclosure should not be limited by any of the above-described example embodiments, but should be defined only in accordance with the following claims and their equivalents.

As described above, this document discloses system, method, and computer program product embodiments by which a vehicle and a dispatching service negotiating an alternate stopping location for a vehicle when a desired stopping location is not reachable. The system embodiments include a processor and memory of the vehicle and/or the dispatching service. The computer program embodiments include programming instructions, e.g., stored in a memory, to cause a processor to perform the data management methods described in this document. The system embodiments also include a processor which is configured to perform the methods described in this document, e.g., via the programming instructions. More generally, the system embodiments include a system comprising means to perform the steps of the any of the methods described in this document.

Without excluding further possible embodiments, certain example embodiments are summarized in the following clauses:

Clause 1. A computer-implemented method of determining a stopping location for a ride service request, the method comprising, by a processor onboard a vehicle: (i) receiving a ride service request, wherein the ride service request includes a desired stopping location (DSL) for a passenger; (ii) in response to the DSL not being a reachable stopping location, using map data received from a map service and sensor data captured by one or more sensors onboard the vehicle to select an intermediate stopping location (ISL); (iii) transmitting, to a dispatching service, a message that includes the ISL; and (iv) in response to determining that the passenger has approved the ISL, using the ISL to identify a final stopping location (FSL), and causing a motion control system of the vehicle to move the vehicle along a route to the FSL.

Clause 2. The method of clause 1, wherein selecting the ISL comprises selecting a location that is within a maximum threshold walking distance from the DSL.

Clause 3: The method of clause 2, further comprising receiving data indicative of a weather condition at the DSL and selecting, as the maximum threshold walking distance, a distance that corresponds to the weather condition.

Clause 4: The method of clause 2 or 3, wherein selecting the ISL also comprises accessing a stopping location rule set that is associated with the dispatching service, and retrieving the maximum threshold walking distance from the stopping location rule set.

Clause 5: The method of any of clauses 2 through 4, wherein selecting the ISL also comprises selecting a location that satisfies at least one of the following rules: (i) the passenger must not need to cross a street when walking from the ISL to the DSL; (ii) the ISL must be located more than a minimum distance from a nearest intersection; or (iii) the ISL must be of at least a minimum size.

Clause 6: The method of any of the preceding clauses, wherein: (i) determining that the passenger has approved the ISL comprises receiving a message from the dispatching service indicating that the passenger has accepted the ISL; and (ii) the FSL is the ISL.

Clause 7: The method of any of the preceding clauses, further comprising, before determining that the passenger has approved the ISL: (a) receiving a message from the dispatching service indicating that the passenger has rejected the ISL; (11) selecting an alternate ISL; and (iii) transmitting, to the dispatching service, a message that includes the alternate ISL. In the embodiment of this clause, determining that the passenger has approved the ISL indicates that the passenger has approved the alternate ISL, and the FSL is the alternate ISL.

Clause 8: The method of any of the preceding clauses, wherein at least some criteria that the processor uses to select the ISL are not communicated to the dispatching service.

Clause 9: The method of any of the preceding clauses, wherein the processor onboard the vehicle and the passenger do not communicate with each other before the processor identifies the FSL and causes the vehicle to move along the route.

Clause 10: A method of determining a final stopping location for a ride service request, the method comprising, by a dispatching service: (i) identifying a ride service request, wherein the ride service request includes a desired stopping location (DSL) for a passenger; (ii) transmitting the ride service request to a vehicle; (iii) receiving, from the vehicle, an intermediate stopping location (ISL) that is an alternative to the DSL; (iv) sending, to the passenger, a message that includes the ISL; (v) in response to determining that the passenger has rejected the ISL, sending, to the vehicle, a message indicating that the passenger has rejected the ISL; and (vi) repeating the receiving step and both sending steps until either the passenger accepts an alternate ISL or the system determines that no suitable ISLs are available.

Clause 11: The method of clause 10, further comprising sending the vehicle a stopping location rule that includes a maximum threshold walking distance, wherein the ISL must satisfy the stopping location rule.

Clause 12: The method of clause 11, further comprising selecting the maximum threshold walking distance based on one or more of the following: (a) a distance that corresponds to a weather condition; or (b) a stopping location rule set that is associated with the dispatching service.

Clause 13: A system comprising means for performing steps of any of the above method clauses.

Clause 14: A computer program, or a storage medium storing the computer program, comprising instructions, which when executed by one or more suitable processors cause any of the processors to perform the steps of any of the above method clauses.

1. A method of determining a stopping location for a ride service request, the method comprising, by a processor onboard a vehicle:
receiving a ride service request, wherein the ride service request includes a desired stopping location (DSL) for a passenger;
in response to the DSL not being a reachable stopping location, using map data received from a map service and sensor data captured by one or more sensors onboard the vehicle to select an intermediate stopping location (ISL);
transmitting, to a dispatching service, a message that includes the ISL; and
in response to determining that the passenger has approved the ISL, using the ISL to identify a final stopping location (FSL), and causing a motion control system of the vehicle to move the vehicle along a route to the FSL.

2. The method of claim 1, wherein selecting the ISL comprises selecting a location that is within a maximum threshold walking distance from the DSL.

3. The method of claim 2, further comprising:
receiving data indicative of a weather condition at the DSL; and
selecting, as the maximum threshold walking distance, a distance that corresponds to the weather condition.

4. The method of claim 2, wherein selecting the ISL also comprises:
accessing a stopping location rule set that is associated with the dispatching service; and
retrieving the maximum threshold walking distance from the stopping location rule set.

5. The method of claim 2, wherein selecting the ISL also comprises selecting a location that satisfies at least one of the following rules:
the passenger must not need to cross a street when walking from the ISL to the DSL;
the ISL must be located more than a minimum distance from a nearest intersection; or
the ISL must be of at least a minimum size.

6. The method of claim 1, wherein:
determining that the passenger has approved the ISL comprises receiving a message from the dispatching service indicating that the passenger has accepted the ISL; and
the FSL is the ISL.

7. The method of claim 1:
further comprising, before determining that the passenger has approved the ISL:
receiving a message from the dispatching service indicating that the passenger has rejected the ISL,
selecting an alternate ISL, and
transmitting, to the dispatching service, a message that includes the alternate ISL;
and wherein:
determining that the passenger has approved the ISL indicates that the passenger has approved the alternate ISL; and
the FSL is the alternate ISL.

8. The method of claim 1, wherein at least some criteria that the processor uses to select the ISL are not communicated to the dispatching service.

9. The method of claim 1, wherein the processor onboard the vehicle and the passenger do not communicate with each other before the processor identifies the FSL and causes the vehicle to move along the route.

10. A computer program product for determining a stopping location for a ride service request, the computer program product comprising a memory device and programming instructions that are configured to cause a processor onboard a vehicle to perform a method comprising:
upon receiving a ride service request, wherein the ride service request includes a desired stopping location (DSL) for a passenger, in response to the DSL not being a reachable stopping location, using map data received from a map service and sensor data captured by one or more sensors onboard the vehicle to select an intermediate stopping location (ISL);
transmitting, to a dispatching service, a message that includes the ISL; and
in response to determining that the passenger has approved the ISL, using the ISL to identify a final stopping location (FSL), and causing a motion control system of the vehicle to move the vehicle along a route to the FSL.

11. The computer program product of claim 10, wherein the instructions to select the ISL comprise instructions to select a location that is within a maximum threshold walking distance from the DSL.

12. The computer program product of claim 11, further comprising additional programming instructions to, upon receiving data indicative of a weather condition at the DSL:
selecting, as the maximum threshold walking distance, a distance that corresponds to the weather condition.

13. The computer program product of claim 11, wherein the instructions to select the ISL also comprise instructions to:
accessing a stopping location rule set that is associated with the dispatching service; and
retrieving the maximum threshold walking distance from the stopping location rule set.

14. The computer program product of claim 11, wherein the instructions to select the ISL also comprise instructions to select a location that satisfies at least one of the following rules:
the passenger must not need to cross a street when walking from the ISL to the DSL;
the ISL must be located more than a minimum distance from a nearest intersection; or
the ISL must be of at least a minimum size.

15. The computer program product of claim 10, further comprising additional programming instructions to determine that the passenger has approved the ISL upon receiving a message from the dispatching service indicating that the passenger has accepted the ISL.

16. The computer program product of claim 10, further comprising additional programming instructions that are configured to cause the processor to:
in response to receiving a message from the dispatching service indicating that the passenger has rejected the ISL:
selecting an alternate ISL, and
transmitting, to the dispatching service, a message that includes the alternate ISL;
after transmitting the message that includes the alternate ISL, determining that the passenger has approved the ISL upon receipt of a message indicating that the passenger has approved the alternate ISL.

17. The computer program product of claim 10, wherein the instructions do not include instructions to communicate to the dispatching service at least some criteria that the processor will use to select the ISL.

18. A method of determining a final stopping location for a ride service request, the method comprising, by a dispatching service:
identifying a ride service request, wherein the ride service request includes a desired stopping location (DSL) for a passenger;
transmitting the ride service request to a vehicle;
receiving, from the vehicle, an intermediate stopping location (ISL) that is an alternative to the DSL;
sending, to the passenger, a message that includes the ISL;
in response to determining that the passenger has rejected the ISL, sending, to the vehicle, a message indicating that the passenger has rejected the ISL; and
repeating the receiving step and both sending steps until either the passenger accepts an alternate ISL or the system determines that no suitable ISLs are available.

19. The method of claim 18, further comprising sending the vehicle a stopping location rule that includes a maximum threshold walking distance, wherein the ISL must satisfy the stopping location rule.

20. The method of claim 19, further comprising selecting the maximum threshold walking distance based on one or more of the following:
a distance that corresponds to a weather condition; or
a stopping location rule set that is associated with the dispatching service.
